(19) United States
(12) Patent Application Publication
(10) Pub. No.: US 2013/0311864 A1
(43) Pub. Date: Nov. 21, 2013

(54) Intelligent and robust context based XML data parsing from spreadsheets

(71) Applicant: N. Nagaraj, San Jose, CA (US)

(72) Inventor: N. Nagaraj, San Jose, CA (US)

(21) Appl. No.: 13/422,191

(22) Filed: May 16, 2012

(51) Int. Cl. G06F 17/27

(52) U.S. Cl. CPC G06F 17/272
USPC 715/212

(57) ABSTRACT

This invention is for a method to make sense of XML (Extensible Markable Language) data when it is imported into spreadsheets without the use of a stylesheet and to accurately capture that data automatically into the appropriate fields. When it is imported into spreadsheets without a stylesheet, the rows and columns are unspecifiable, and even for similar XML files having different sets of data, the rows and columns may not always correspond exactly, as it would with form data where each data field always has a place holder. The method developed by this claim uniquely addresses the issue of absorbing this data by cross indexing all descendant elements and attributes pillared around a mandatory element and attribute for one direction, and keeping an open spring like data sensing mechanism in the vertical direction, with resulting data read being instantly captured accurately, associated with the proper data field and validated.

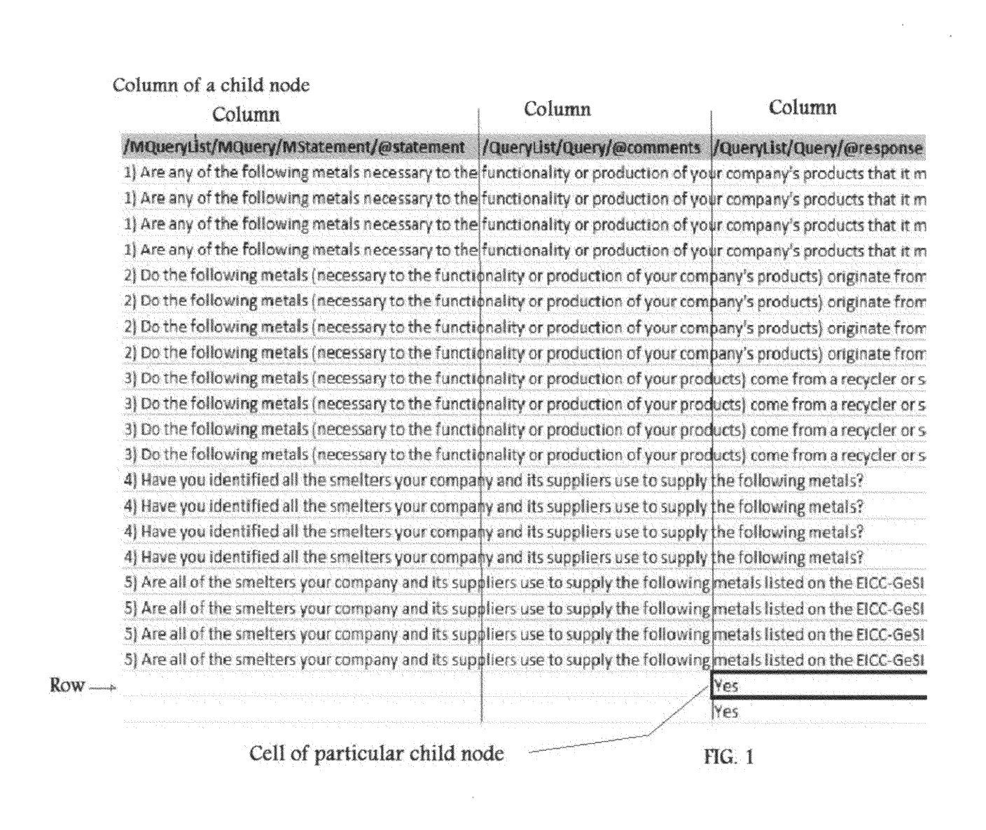

The illustration in attached drawing (captioned FIG. 1) shows the typical problem that is encountered in opening an XML in a spreadsheet that can parse and bring in the the XML in a read only mode into a spreadsheet format with column headers showing the full node address including traced parentage, current element and attribute.

A description of this drawing is attached that shows the challenge in obtaining a value of a data parameter from the cell location alone in terms of row or column numbers.

The claim addresses this issue uniquely. The method developed is far superior to any general XML parsing because it combines apriori information about the DOM structure, while allowing for extreme flexibility in terms of allowing mandatory as well as optional fields. For complex XML data which is not 2-dimensional in hierarchy, this causes an asynchronous structure in the planar spreadsheet view when opened in spreadsheets. Therefore, no other method other than the claimant's is able to quickly and accurately read complex XML data into spreadsheets and associate them with the appropraite data fields. The method developed by this claim uniquely addresses the issue of absorbing this data by cross indexing all descendant elements and attributes pillared around a mandatory element and attribute for one direction, and keeping an open spring like data sensing mechanism in the vertical direction, with resulting data read being instantly validated.

The claim follows an established practice by claimant of this method at the international level by distribution with thousands of installations at the largest multinational corporations. Even after several years of these products being on the market, there is no other product that addresses this problem in this mariner as has the claimant. The resulting robustness from the claimant's practice is widely acclaimed in industry.

### DESCRIPTION OF DRAWING SUBMITTED

The drawing (FIG. 1) submitted is a depiction with annotations of a file for tracking minerals in the supply chain using a XML based data file, using a spreadsheet interface which because it is two dimensional will lay the data according to the tree/DOM level index of the child nodes in a two-dimensional lay out. This means that for the same schema, very often these column and row locations of a piece of data can be at different locations making it difficult to track complex XML data using the two-dimensional state. The floating nature of this data structure in two dimensions means that mining the data requires sophisticated cross-indexing that can automate the mining of such data using apriori knowledge of the schema, but with no need for a XSLT stylesheet (which are not always easy to create for complex schemas) to interface the data to the spreadsheet.

1. Intelligent and robust context based XML data parsing from spreadsheets using an unique indexing scheme and iterative spring like vertical data explorer.
